(19) United States
(12) Patent Application Publication
(10) Pub. No.: US 2025/0322848 A1
(43) Pub. Date: Oct. 16, 2025

(54) ELECTRONIC APPARATUS CAPABLE OF PERFORMING SYNCHRONIZATION BETWEEN DOCUMENT AND VOICE THROUGH MATCHING BETWEEN VOICE AND EDITING OBJECT, AND OPERATION METHOD THEREOF

(71) Applicant: FLEXCIL INC., Seongnam-si, Gyeonggi-do (KR)

(72) Inventors: Sung Phil JEON, Seongnam-si, Gyeonggi-do (KR); Ji Hoon PARK, Seongnam-si, Gyeonggi-do (KR)

(73) Assignee: FLEXCIL INC., Seongnam-si, Gyeonggi-do (KR)

(21) Appl. No.: 18/577,281

(22) PCT Filed: Jul. 22, 2022
(86) PCT No.: PCT/KR2022/010766

§ 371 Date: Jul. 1, 2024

(30) Foreign Application Priority Data
Jul. 26, 2021 (KR) 10-2021-0097527

(51) Int. Cl. G11B 20/10; G06F 40/166; G10L 13/027

(52) U.S. Cl. CPC G11B 20/10527; G06F 40/166; G10L 13/027; G11B 2020/10546

(57) ABSTRACT

Disclosed are an electronic apparatus capable of synchronizing between documents and voices through matching between a voice and an editing object, and operating method thereof. The present invention provides an electronic apparatus capable of synchronizing between documents and voices through matching between a voice and an editing object, and an operating method thereof, when a user edits a document while recording the voice to support the user to view editing objects inserted into the document in chronological order at the time when recording the voice.

### TECHNICAL FIELD

The present invention relates to an electronic apparatus capable of synchronizing documents and voices through matching between a voice and an editing object when the user edits a document while recording a voice, and an operating method thereof.

### BACKGROUND ART

Recently, as electronic apparatuses such as tablet PCs and laptops become widely available, the number of cases where users edit documents while recording lectures or their own voices through these electronic apparatuses is increasing.

In this regard, in the existing technology, when a user performs document editing while recording a voice, matching between the voice and the editing object is not performed, so when the user reproduces voice data later, on the document, it is not easy to show a screen where each editing object is inserted according to the reproduction time of the voice data.

Here, the editing object means a predetermined item such as a figure, an image, a text box, etc., which may be inserted into the document by the user.

If technology is introduced in which when the user edits the document while recording the voice, matching between the voice and the editing object is possible, so that when the user later listens to the recorded voice, a scene in which each editing object of which insertion is completed is inserted can be expressed according to a preproduction time of the voice, it will be able to be possible for the user to be more quickly familiar with the document in that the user can view editing objects inserted into the document in chronological order at the time of recording the voice.

Therefore, research is needed on technology that supports synchronization between the document and voice through matching between the voice and the editing object when the user edits a document while recording his or her voice.

### DISCLOSURE

### Technical Problem

The present invention provides an electronic apparatus capable of synchronizing between documents and voices through matching between a voice and an editing object, and an operating method thereof, when a user edits a document while recording the voice to support the user to view editing objects inserted into the document in chronological order at the time of recording the voice.

### Technical Solution

According to an embodiment of the present invention, an electronic apparatus capable of synchronizing between documents and voices through matching between a voice and an editing object when a user edits the document while recording the voice includes: a voice data generation unit recording, when a voice recording start instruction is received by the user in a state in which a plurality of different documents are being edited, wherein unique identifiers for identifying respective documents are assigned to the plurality of documents, respectively, a voice applied through a microphone to generate voice data; a table recording unit recording information on the editing object and a time of inserting the editing object and a unique identifier assigned to any one document to correspond to each other in an object table whenever inserting the editing object is completed in any one document among the plurality of documents by the user while recording the voice; an ending unit ending recording of the voice and data recording in the object table when a voice recording end instruction is received by the user; and a reproduction unit reproducing the voice data when a reproduction instruction for the voice data is received by the user after the recording for the voice and the data recording in the object table are ended, and confirming information on the editing object and the unique identifier of the document according to each reproduction time, which are recorded in the object table whenever a reproduction time corresponding to the time when inserting each editing object recorded in the object table is completed is reached to display a scene in which the editing object is inserted according to each reproduction time in the document having the unique identifier according to each reproduction time on a screen.

Further, according to an embodiment of the present invention, an operating method of an electronic apparatus capable of synchronizing between documents and voices through matching between a voice and an editing object when a user edits the document while recording the voice includes: recording, when a voice recording start instruction is received by the user in a state in which a plurality of different documents are being edited, wherein unique identifiers for identifying respective documents are assigned to the plurality of documents, respectively, a voice applied through a microphone to generate voice data; recording information on the editing object and a time of inserting the editing object and a unique identifier assigned to any one document to correspond to each other in an object table whenever inserting the editing object is completed in any one document among the plurality of documents by the user while recording the voice; ending recording of the voice and data recording in the object table when a voice recording end instruction is received by the user; and reproducing the voice data when a reproduction instruction for the voice data is received by the user after the recording for the voice and the data recording in the object table are ended, and confirming information on the editing object and the unique identifier of the document according to each reproduction time, which are recorded in the object table whenever a reproduction time corresponding to the time when inserting each editing object recorded in the object table is completed is reached to display a scene in which the editing object is inserted according to each reproduction time in the document having the unique identifier according to each reproduction time on a screen.

### Advantageous Effects

The present invention provides an electronic apparatus capable of synchronizing between documents and voices through matching between a voice and an editing object, and an operating method thereof, when a user edits a document while recording the voice to support the user to view editing objects inserted into the document in chronological order at the time of recording the voice.

### DESCRIPTION OF DRAWINGS

FIG. 1 is a diagram illustrating a structure of an electronic apparatus capable of synchronization between documents and voices through matching between a voice and an editing object according to an embodiment of the present invention.

FIG. 2 is a flowchart illustrating an operating method of an electronic apparatus which may perform synchronization between documents and voices through matching between a voice and an editing object according to an embodiment of the present invention.

### BEST MODE

Hereinafter, exemplary embodiments of the present invention will be described in detail with reference to the accompanying drawings. The description does not limit the present invention to specific exemplary embodiments, and it should be understood that the present invention covers all the modifications, equivalents and replacements included within the idea and technical scope of the present invention. In describing each drawing, like reference numerals refer to like elements and if not contrarily defined, all terms used herein including technological or scientific terms have the same meanings as those generally understood by a person with ordinary skill in the art.

In this document, unless explicitly described to the contrary, the word “comprise” and variations such as “comprises” or “comprising”, will be understood to imply the inclusion of stated elements but not the exclusion of any other elements. Further, in various exemplary embodiments of the present invention, each of components, functional blocks or means may be constituted by one or more lower components and electrical, electronic, and mechanical functions performed by respective components may be implemented as various known devices or mechanical elements including an electronic circuit, an integrated circuit, an Application Specific Integrated Circuit (ASIC), etc., and the respective components may be separately implemented or two or more components may be integrated into one and implemented.

Meanwhile, blocks of the accompanying block diagram or steps of a flowchart may be appreciated as meaning compute program instructions mounted on a processor or a memory of data processible equipment such as a universal computer, a special computer, a portable notebook computer, a network computer, etc., and performing designated functions. Since the computer program instructions may be stored in a memory provided in a computer device or a computer readable memory, functions described in blocks of a block diagram or steps of a flowchart may be produced as a manufactured object including an instruction mean performing the functions. Moreover, each block or each step may represent a part of a module, a segment, or a code that includes one or more executable instructions for executing a specified logical function(s). It should also be noted that in some replaceable embodiments, the functions mentioned in the blocks or steps may also be executed differently from a predetermined order. For example, two blocks or steps that are subsequently illustrated are substantially simultaneously carried out, or may be performed in a reverse order, and in some cases, the functions may be performed while some blocks or steps are omitted.

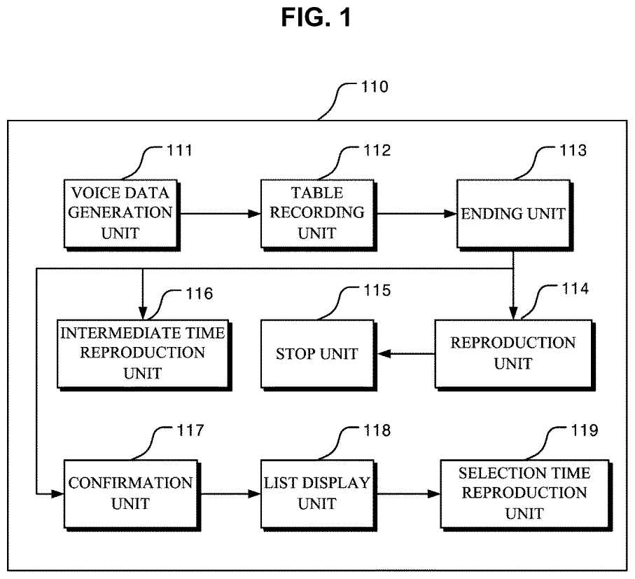

FIG. 1 is a diagram illustrating a structure of an electronic apparatus which may perform synchronization between documents and voices through matching between a voice and an editing object according to an embodiment of the present invention.

Referring to FIG. 1, the electronic apparatus 110 according to the present invention as an apparatus that may perform synchronization between the documents and the voices through matching between the voice and the editing object when the user edits a document while recording the voice includes a voice data generation unit 111, a table recording unit 112, an ending unit 113, and a reproduction unit 114.

The voice data generation unit 111 generates voice data by recording a voice applied through a microphone when a voice recording start instruction is received by the user while a plurality of different documents are being edited.

Here, each of the plurality of documents is assigned with a unique identifier to identify each document.

The table recording unit 112 records information on the editing object and a time of inserting the editing object and a unique identifier assigned to any one document to correspond to each other in an object table whenever inserting the editing object is completed in any one document among the plurality of documents by the user while recording the voice.

Here, the editing object means a predetermined item such as a figure, an image, a text box, etc., which may be inserted into the document by the user.

The ending unit 113 ends recording of the voice and data recording in the object table when a voice recording ending instruction is received by the user.

The reproduction unit 114 reproduces the voice data when a reproduction instruction for the voice data is received by the user after the recording for the voice and the data recording in the object table are ended, and confirms information on the editing object and the unique identifier of the document according to each reproduction time, which are recorded in the object table whenever a reproduction time corresponding to the time when inserting each editing object recorded in the object table is completed is reached to display a scene in which the editing object is inserted according to each reproduction time in the document having the unique identifier according to each reproduction time on a screen.

Hereinafter, operations of the voice data generation unit 111, the table recording unit 112, the ending unit 113, and the reproduction unit 114 will be described in detail as an example.

First, it is assumed that a plurality of different documents are ‘document 1, document 2, and document 3’. In this case, when the electronic apparatus 110 receives a voice recording start instruction by the user in the state in which ‘document 1, document 2, and document 3’ which are the plurality of documents are being edited, the voice data generation unit 111 records the voice applied through a microphone to generate voice data.

The table recording unit 112 may record information on the editing object and a time of inserting the editing object and a unique identifier assigned to any one document to correspond to each other in an object table whenever inserting the editing object is completed in any one document among ‘document 1, document 2, and document 3’ by the user while recording the voice.

When it is assumed that inserting the editing object is completed ‘three times in document 1’, twice in ‘document 2’, and once in ‘document 3’ in order of ‘document 1, document 2, and document 3’ by the user while the voice is recorded, the table recording unit 112 may record information on the editing object and a time when the editing object is inserted and a unique identifier assigned to each document to correspond to each other on an object table as in Table 1 below.

TABLE 1
Object table

| | | |
|---|---|---|
| Editing object 1 | Insertion time 1 (1 | Unique identifier 1 of |
| | minute 5 seconds) | document 1 |
| Editing object 2 | Insertion time 2 (1 | Unique identifier 1 of |
| | minute 10 seconds) | document 1 |
| Editing object 3 | Insertion time 3 (1 | Unique identifier 1 of |
| | minute 25 seconds) | document 1 |
| Editing object 4 | Insertion time 4 (2 | Unique identifier 2 of |
| | minutes 15 seconds) | document 2 |
| Editing object 5 | Insertion time 5 (2 | Unique identifier 2 of |
| | minutes 20 seconds) | document 2 |
| Editing object 6 | Insertion time 6 (3 | Unique identifier 3 of |
| | minutes 5 seconds) | document 3 |

In this case, when the electronic apparatus 110 receives the voice recording ending instruction by the user, the ending unit 113 may end recording of the voice and data recording in the object table.

In this regard, it is assumed that the ending unit 113 ends the recording for the voice in ‘3 minutes 30 seconds’, and ends the data recording for the object table.

In this case, when the electronic apparatus 110 receives a reproduction instruction for the voice data by the user, the reproduction unit 114 may reproduce the voice data, and confirm, whenever ‘reproduction time 1 (1 minute 5 seconds), reproduction time 2 (1 minute 10 seconds), reproduction time 3 (1 minute 25 seconds), reproduction time 4 (2 minutes 15 seconds), reproduction time 5 (2 minutes 20 seconds), and reproduction time 6 (3 minutes 5 seconds)’ are reached, which are reproduction times correspond to ‘insertion time 1 (1 minute 5 seconds), insertion time 2 (1 minute 10 seconds), insertion time 3 (1 minute 25 seconds), insertion time 4 (2 minutes 15 seconds), insertion time 5 (2 minutes 20 seconds), and insertion time 6 (3 minutes 5 seconds)’ which are times when inserting respective editing objects recorded in the object table is completed, information on ‘editing object 1, editing object 2, editing object 3, editing object 4, editing object 5, and editing object 6’ which are editing objects according to the respective reproduction times recorded in the object table, and ‘unique identifier 1, unique identifier 2, and unique identifier 3’ which are unique identifiers of ‘document 1, document 2, and document 3’.

Thereafter, the reproduction unit 114 may display a scene in which ‘editing object 1, editing object 2, editing object 3, editing object 4, editing object 5, and editing object 6’ which are the editing objects according to the respective reproduction times are inserted on ‘document 1, document 2, and document 3’ which are documents having ‘unique identifier 1, unique identifier 2, and unique identifier 3’ which are the unique identifiers according to the respective reproduction times on the screen.

More specifically, the reproduction unit 114 may display a scene in which ‘editing object 1’ is inserted in ‘document 1’ on the screen when the reproduction time of the voice data becomes ‘reproduction time 1 (1 minute 5 seconds), display a scene in which ‘editing object 2’ is inserted in ‘document 1’ on the screen when the reproduction time of the voice data becomes ‘reproduction time 2 (1 minute 10 seconds), display a scene in which ‘editing object 3’ is inserted in ‘document 1’ on the screen when the reproduction time of the voice data becomes ‘reproduction time 3 (1 minute 25 seconds), display a scene in which ‘editing object 4’ is inserted in ‘document 2’ on the screen when the reproduction time of the voice data becomes ‘reproduction time 4 (2 minutes 15 seconds), display a scene in which ‘editing object 5’ is inserted in ‘document 2’ on the screen when the reproduction time of the voice data becomes ‘reproduction time 5 (2 minutes 20 seconds), and display a scene in which ‘editing object 6’ is inserted in ‘document 3 on the screen when the reproduction time of the voice data becomes ‘reproduction time 6 (3 minutes 5 seconds).

Through this, the user may view the editing objects inserted into the documents in chronological order at the time of recording the voice.

According to an embodiment of the present invention, the electronic apparatus 110 may further include a stop unit 115.

When a reproduction stop instruction for the voice data is received by the user at a first reproduction time while reproducing the voice data, the stop unit 115 inserts editing objects having an insertion time before the first reproduction time into the plurality of documents by referring to the object table, and then switches the plurality of documents in an editable state, and displays the editable documents on the screen.

For example, it is assumed that the first reproduction time is ‘reproduction time 7 (1 minute 30 seconds), and the electronic apparatus 110 receives the reproduction stop instruction for the voice data by the user at ‘reproduction time 7 (1 minute 30 seconds) while the voice data is reproduced through the reproduction unit 114.

Then, the stop unit 115 may insert ‘editing object 1, editing object 2, and editing object 3’ which are editing objects having insertion times before ‘reproduction time 7 (1 minute 30 seconds) into ‘document 1’ by referring to the object table shown in Table 1 above, and then switch ‘document 1, document 2, and document 3’ which are the plurality of documents to the editable state, and display the editable documents on the screen.

Through this, the user may newly edit ‘document 1, document 2, and document 3’ in the state in which the editing objects up to ‘reproduction time 7 (1 minute 30 seconds)’ are inserted

According to an embodiment of the present invention, the electronic apparatus 110 may further include an intermediate time reproduction unit 116.

When an intermediate time reproduction instruction of reproducing the voice data is received from a second reproduction time by the user, the intermediate time reproduction unit 116 reproduces the voice data from the second reproduction time, and inserts editing objects having insertion times before the second reproduction time the plurality of documents by referring to the object table, and then confirms information on the editing object according to each the reproduction time recorded in the object table, and the unique identifier of the document, whenever the reproduction time corresponding to the time in which each editing object recorded in the object table is inserted is reached from the second reproduction time, and displays a scene in which the editing object according to each reproduction time is inserted on the document having the unique identifier according to each reproduction time on the screen.

For example, it is assumed that the second reproduction time ‘reproduction time 8 (2 minutes 17 seconds), and the electronic apparatus 110 receives an intermediate time reproduction instruction of reproducing the voice data from ‘reproduction time 8 (2 minutes 17 seconds)’ by the user.

Then, the intermediate time reproduction unit 116 may reproduce the voice data from ‘reproduction time 8 (2 minutes 17 seconds)’, and insert ‘editing object 1, editing object 2, and editing object 3’ which are editing objects having insertion times before ‘reproduction time 8 (2 minute 17 seconds)’ into ‘document 1’ and ‘editing object 4’ into ‘document 2’ by referring to the object table shown in Table 1 above.

Thereafter, the intermediate time reproduction unit 116 may confirm information on ‘editing object 5 and editing object 6’ which are the editing objects according to the respective reproduction times recorded in the object table and ‘unique identifier 2 and unique identifier 3’ which are the unique identifiers of ‘document 2 and document 3’, whenever ‘reproduction time 5 (2 minutes 20 seconds) and reproduction time 6 (3 minutes 5 seconds)’ which are reproduction times corresponding to ‘insertion time 5 (2 minutes 20 seconds) and insertion time 6 (3 minutes 5 seconds)’ which are the times in which the respective editing objects recorded in the object table are inserted are inserted from ‘reproduction time 8 (2 minutes 17 seconds)’.

Then, the intermediate time reproduction unit 116 may display a scene in which ‘editing object 5 and editing object 6’ which are the editing objects according to the respective reproduction times are inserted on ‘document 2 and document 3’ which are documents having ‘unique identifier 2 and unique identifier 3’ which are the unique identifiers according to the respective reproduction times on the screen.

More specifically, the intermediate time reproduction unit 116 may display a scene in which ‘editing object 5’ is inserted in ‘document 2’ on the screen when the reproduction time of the voice data becomes ‘reproduction time 5 (2 minutes 20 seconds)’, and display a scene in which ‘editing object 6’ is inserted in ‘document 3’ on the screen when the reproduction time of the voice data becomes ‘reproduction time 6 (3 minutes 5 seconds)’.

According to an embodiment of the present invention, the electronic apparatus 110 may further include a confirmation unit 117 and a list display unit 118.

When a list display instruction instructing a list of editing objects inserted at a third reproduction time of the voice data to be displayed is received by the user, the confirmation unit 117 confirms whether there is an editing object having an insertion time which belongs to a predetermined first time before or after the third reproduction time by referring to the object table.

When it is confirmed that there is at least one first editing object as an editing object having the insertion time which belongs to the first time before and after the third reproduction time, the list display unit 118 extracts information on the at least one first editing object and a unique identifier of a document corresponding to each of the information on the at least one first editing object from the object table, and then configures an editing object list including the information on the at least one first editing object and the unique identifier of the document corresponding to the each of the information on the at least one first editing object, and displays the editing object list on the screen.

For example, it is assumed that the predetermined first time is ‘15 seconds’, the third reproduction time is ‘reproduction time 9 (1 minute 15 seconds)’, and the electronic apparatus 110 receives a list display instruction instructing a list of editing objects inserted at ‘reproduction time 9 (1 minute 15 seconds) of the voice data to be displayed by the user’.

Then, the confirmation unit 117 may confirm whether there is an editing object having an insertion time which belongs within ‘15 seconds’ before and after ‘reproduction time 9 (1 minute 15 seconds)’ by referring to the object table shown in Table 1 above.

In this case, since there are ‘editing object 1, editing object 2, and editing object 3’ as the editing object having the insertion time which belongs within ‘15 seconds’ before or after ‘reproduction time 9 (1 minute 15 seconds)’ in the object table shown in Table 1 above, the list display unit 118 may extract information on ‘editing object 1, editing object 2, and editing object 3’, and ‘unique identifier 1’ which is a unique identifier of ‘document 1’ which is a document corresponding to each of the information on ‘editing object 1, editing object 2, and editing object 3’ from the object table.

Thereafter, the list display unit 118 may configure the editing object list including the information on ‘editing object 1, editing object 2, and editing object 3’, and ‘unique identifier 1’ which is the unique identifier of ‘document 1’, and display the editing object list on the screen.

According to an embodiment of the present invention, the electronic apparatus 110 may further include a selection time reproduction unit 119.

The selection time reproduction unit 119 reproduces the voice data from a fourth reproduction time corresponding to a time in which the second editing object is inserted when the editing object list is displayed on the screen, and then a selection instruction of information on a second editing object which is any one of the information on the at least one first editing object included in the editing object list is received by the user, and reflects editing objects having an insertion time before the fourth reproduction time on the plurality of documents by referring to the object table, and then confirms information on an editing object according to each reproduction time recorded in the object table, and a unique identifier of a document whenever a reproduction time corresponding to a time in which each editing object recorded in the object table is inserted from the fourth reproduction time, and displays a scene in which the editing object according to each reproduction time is inserted on the document having the unique identifier according to each reproduction time on the screen.

For example, as in the above-described example, it is assumed that after the list display unit 118 displays the editing object list including the information ‘editing object 1, editing object 2, and editing object 3’, and ‘unique identifier 1’ on the screen, the electronic apparatus 110 receives a selection instruction of the information on ‘editing object 3’ which is any one information of ‘editing object 1, editing object 2, and editing object 3’ include in the editing object list by the user.

Then, the selection time reproduction unit 119 may reproduce the voice data from ‘reproduction time 3 (1 minutes 25 seconds)’ corresponding to ‘insertion time 3 (1 minute 25 seconds)’ which is the time in which ‘editing object 3’ is inserted, and insert ‘editing object 1, editing object 2, and’ which are editing objects having insertion times before ‘reproduction time 3 (1 minute 25 seconds)’ into ‘document 1’ by referring to the object table shown in Table 1 above.

Thereafter, the selection time reproduction unit 119 may confirm information on ‘editing object 4, editing object 5, and editing object 6’ which are the editing objects according to the respective reproduction times recorded in the object table and ‘unique identifier 2 and unique identifier 3’ which are the unique identifiers of ‘document 2 and document 3’, whenever ‘reproduction time 4, (2 minutes 15 seconds), reproduction time 5 (2 minutes 20 seconds), and reproduction time 6 (3 minutes 5 seconds)’ which are reproduction times corresponding to ‘insertion time 4 (2 minutes 15 seconds), insertion time 5 (2 minutes 20 seconds), and insertion time 6 (3 minutes 5 seconds)’ which are the times in which the respective editing objects recorded in the object table are inserted are reached from ‘reproduction time 3 (1 minutes 25 seconds)’.

Then, the selection time reproduction unit 119 may display a scene in which ‘editing object 4, editing object 5, and editing object 6’ which are the editing objects according to the respective reproduction times are inserted on ‘document 2, and document 3’ which are documents having ‘unique identifier 2 and unique identifier 3’ which are the unique identifiers according to the respective reproduction times on the screen.

More specifically, the selection time reproduction unit 119 may display a scene in which ‘editing object 4’ is inserted in ‘document 2’ on the screen when the reproduction time of the voice data becomes ‘reproduction time 4 (2 minutes 15 seconds)’, display a scene in which ‘editing object 5’ is inserted in ‘document 2’ on the screen when the reproduction time of the voice data becomes ‘reproduction time 5 (2 minutes 20 seconds)’, and display a scene in which ‘editing object 6’ is inserted in ‘document 3’ on the screen when the reproduction time of the voice data becomes ‘reproduction time 6 (3 minutes 5 seconds)’.

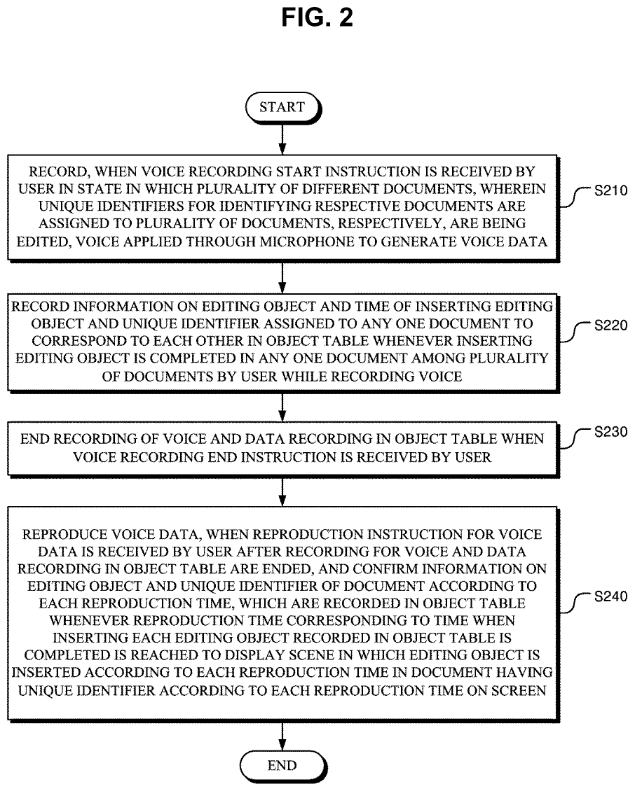

FIG. 2 is a flowchart illustrating an operating method of an electronic apparatus which may perform synchronization between documents and voices through matching between a voice and an editing object when a user edits the document while recording the voice according to an embodiment of the present invention.

In step S210, when a voice recording start instruction is received by the user in a state in which a plurality of different documents (unique identifiers for identifying respective documents are assigned to the plurality of documents, respectively) are being edited, a voice applied through a microphone is recorded to generate voice data.

In step S220, information on the editing object and a time of inserting the editing object and a unique identifier assigned to any one document to are recorded to correspond to each other in an object table whenever inserting the editing object is completed in any one document among the plurality of documents by the user while recording the voice.

In step S230, recording of the voice and data recording in the object table are ended when a voice recording end instruction is received by the user.

In step S240, the voice data is reproduced when a reproduction instruction for the voice data is received by the user after the recording for the voice and the data recording in the object table are ended, and information on the editing object and the unique identifier of the document according to each reproduction time, which are recorded in the object table are confirmed whenever a reproduction time corresponding to the time when inserting each editing object recorded in the object table is completed is reached to display a scene in which the editing object is inserted according to each reproduction time in the document having the unique identifier according to each reproduction time on a screen.

In this case, according to an embodiment of the present invention, the operating method of the electronic apparatus may further include a step of inserting, when a reproduction stop instruction for the voice data is received by the user at a first reproduction time while reproducing the voice data, editing objects having an insertion time before the first reproduction time into the plurality of documents by referring to the object table, and then switching the plurality of documents in an editable state, and displaying the editable documents on the screen.

Further, according to an embodiment of the present invention, the operating method of the electronic apparatus may further include a step of reproducing, when an intermediate time reproduction instruction of reproducing the voice data is received from a second reproduction time by the user, the voice data from the second reproduction time, and inserting editing objects having insertion times before the second reproduction time the plurality of documents by referring to the object table, and then confirming information on the editing object according to each the reproduction time recorded in the object table, and the unique identifier of the document, and displaying a scene in which the editing object according to each reproduction time is inserted on the document having the unique identifier according to each reproduction time on the screen, whenever a reproduction time corresponding to the time in which each editing object recorded in the object table is inserted is reached from the second reproduction time.

Further, according to an embodiment of the present invention, the operating method of the electronic apparatus may further include a step of confirming, when a list display instruction instructing display a list of editing objects inserted at a third reproduction time of the voice data is received by the user, whether there is an editing object having an insertion time which belongs to a predetermined first time before or after the third reproduction time by referring to the object table, and a step of extracting, when it is confirmed that there is at least one first editing object as an editing object having the insertion time which belongs to the first time before and after the third reproduction time, information on the at least one first editing object and a unique identifier of a document corresponding to each of the information on the at least one first editing object from the object table, and then configuring an editing object list including the information on the at least one first editing object and the unique identifier of the document corresponding to the each of the information on the at least one first editing object, and displaying the editing object list on the screen.

In this case, according to an embodiment of the present invention, the operating method of the electronic apparatus may further include a step of reproducing the voice data from a fourth reproduction time corresponding to a time in which the second editing object is inserted when the editing object list is displayed on the screen, and then a selection instruction of information on a second editing object which is any one of the information on the at least one first editing object included in the editing object list is received by the user, and reflecting editing objects having an insertion time before the fourth reproduction time on the plurality of documents by referring to the object table, and then confirming information on an editing object according to each reproduction time recorded in the object table, and a unique identifier of a document whenever a reproduction time corresponding to a time in which each editing object recorded in the object table is inserted’? from the fourth reproduction time, and displaying a scene in which the editing object according to each reproduction time is inserted on the document having the unique identifier according to each reproduction time on the screen.

Hereinabove, the operating method of the electronic apparatus according to an embodiment of the present invention is described with reference to FIG. 2. Here, since the operating method of the electronic apparatus according to an exemplary embodiment of the present invention may correspond to the configuration of the operation of the electronic apparatus 110 described by using FIG. 1, a more detailed description thereof will be omitted.

The operating method of the electronic apparatus capable of synchronizing between documents and voices through matching between a voice and an editing object according to an exemplary embodiment of the present invention may be implemented by a computer program stored in a storage medium for executing the computer program through coupling with a computer.

Further, Further, the operating method of the electronic apparatus capable of synchronizing between documents and voices through matching between a voice and an editing object according to an embodiment of the present invention may be implemented in a computer program instruction form for executing the computer program through coupling with a computer, and recording a computer-readable medium. The computer readable medium may include a program command, a data file, a data structure, etc., singly or combinationally. The program command recorded in the medium may be specially designed and configured for the present invention, or may be publicly known to and used by those skilled in the computer software field. An example of the computer readable recording medium includes magnetic media, such as a hard disk, a floppy disk, and a magnetic tape, optical media such as a CD-ROM and a DVD, magneto-optical media such as a floptical disk, and hardware devices such as a ROM, a RAM, and a flash memory, which are specially configured to store and execute the program command. An example of the program command includes a high-level language code executable by a computer by using an interpreter and the like, as well as a machine language code created by a compiler.

As described above, the present invention has been described by specified matters such as detailed components, and the like and limited exemplary embodiments and drawings, but the description is just provided to assist more overall understanding of the present invention and the present invention is not limited to the exemplary embodiment and various modifications and changes can be made by those skilled in the art from such a disclosure.

Accordingly, the spirit of the present invention should not be defined only by the described exemplary embodiments, and it should be appreciated that claims to be described below and all things which are equivalent to the claims or equivalently modified to the claims are included in the scope of the spirit of the present invention.

1. An electronic apparatus capable of synchronizing between documents and voices through matching between a voice and an editing object when a user edits the document while recording the voice, the electronic apparatus comprising:
a voice data generation unit recording, when a voice recording start instruction is received by the user in a state in which a plurality of different documents are being edited, wherein unique identifiers for identifying respective documents are assigned to the plurality of documents, respectively, a voice applied through a microphone to generate voice data;
a table recording unit recording information on the editing object and a time of inserting the editing object and a unique identifier assigned to any one document to correspond to each other in an object table whenever inserting the editing object is completed in any one document among the plurality of documents by the user while recording the voice;
an ending unit ending recording of the voice and data recording in the object table when a voice recording end instruction is received by the user; and
a reproduction unit reproducing voice data when a reproduction instruction for the voice data is received by the user after the recording for the voice and the data recording in the object table are ended, and confirming information on the editing object and the unique identifier of the document according to each reproduction time, which are recorded in the object table whenever a reproduction time corresponding to the time when inserting each editing object recorded in the object table is completed is reached to display a scene in which the editing object is inserted according to each reproduction time in the document having the unique identifier according to each reproduction time on a screen.

2. The electronic apparatus of claim 1, further comprising:
a stop unit inserting, when a reproduction stop instruction for the voice data is received by the user at a first reproduction time while reproducing the voice data, editing objects having an insertion time before the first reproduction time into the plurality of documents by referring to the object table, and then switching the plurality of documents in an editable state, and displaying the editable documents on the screen.

3. The electronic apparatus of claim 1, further comprising:
an intermediate time reproduction unit reproducing, when an intermediate time reproduction instruction of reproducing the voice data is received from a second reproduction time by the user, the voice data from the second reproduction time, and inserting editing objects having insertion times before the second reproduction time the plurality of documents by referring to the object table, and then confirming information on the editing object according to each the reproduction time recorded in the object table, and the unique identifier of the document, and displaying a scene in which the editing object according to each reproduction time is inserted on the document having the unique identifier according to each reproduction time on the screen, whenever a reproduction time corresponding to the time in which each editing object recorded in the object table is inserted is reached from the second reproduction time.

4. The electronic apparatus of claim 1, further comprising:
a confirmation unit confirming, when a list display instruction instructing a list of editing objects inserted at a third reproduction time of the voice data to be displayed is received by the user, whether there is an editing object having an insertion time which belongs to a predetermined first time before or after the third reproduction time by referring to the object table; and
a list display unit extracting, when it is confirmed that there is at least one first editing object as an editing object having the insertion time which belongs to the first time before and after the third reproduction time, information on the at least one first editing object and a unique identifier of a document corresponding to each of the information on the at least one first editing object from the object table, and then configuring an editing object list including the information on the at least one first editing object and the unique identifier of the document corresponding to the each of the information on the at least one first editing object, and displaying the editing object list on the screen.

5. The electronic apparatus of claim 4, further comprising:
a selection time reproduction unit reproducing the voice data from a fourth reproduction time corresponding to a time in which the second editing object is inserted when the editing object list is displayed on the screen, and then a selection instruction of information on a second editing object which is any one of the information on the at least one first editing object included in the editing object list is received by the user, and reflecting editing objects having an insertion time before the fourth reproduction time on the plurality of documents by referring to the object table, and confirming information on an editing object according to each reproduction time recorded in the object table, and a unique identifier of a document whenever a reproduction time corresponding to a time in which each editing object recorded in the object table is inserted from the fourth reproduction time, and displaying a scene in which the editing object according to each reproduction time is inserted on the document having the unique identifier according to each reproduction time on the screen.

6. An operating method of an electronic apparatus capable of synchronizing between documents and voices through matching between a voice and an editing object when a user edits the document while recording the voice, the operating method comprising:
recording, when a voice recording start instruction is received by the user in a state in which a plurality of different documents are being edited, wherein unique identifiers for identifying respective documents are assigned to the plurality of documents, respectively, a voice applied through a microphone to generate voice data;
recording information on the editing object and a time of inserting the editing object and a unique identifier assigned to any one document to correspond to each other in an object table whenever inserting the editing object is completed in any one document among the plurality of documents by the user while recording the voice;
ending recording of the voice and data recording in the object table when a voice recording end instruction is received by the user; and
reproducing the voice data, when a reproduction instruction for the voice data is received by the user after the recording for the voice and the data recording in the object table are ended, and confirming information on the editing object and the unique identifier of the document according to each reproduction time, which are recorded in the object table whenever a reproduction time corresponding to the time of inserting each editing object recorded in the object table is completed is reached to display a scene in which the editing object is inserted according to each reproduction time in the document having the unique identifier according to each reproduction time on a screen.

7. The operating method of claim 6, further comprising:
inserting, when a reproduction stop instruction for the voice data is received by the user at a first reproduction time while reproducing the voice data, editing objects having an insertion time before the first reproduction time into the plurality of documents by referring to the object table, and then switching the plurality of documents in an editable state, and displaying the editable documents on the screen.

8. The operating method of claim 6, further comprising:
reproducing, when an intermediate time reproduction instruction of reproducing the voice data is received from a second reproduction time by the user, the voice data from the second reproduction time, and inserting editing objects having insertion times before the second reproduction time the plurality of documents by referring to the object table, and then confirming information on the editing object according to each the reproduction time recorded in the object table, and the unique identifier of the document, and displaying a scene in which the editing object according to each reproduction time is inserted on the document having the unique identifier according to each reproduction time on the screen, whenever a reproduction time corresponding to the time in which each editing object recorded in the object table is inserted is reached from the second reproduction time.

9. The operating method of claim 6, further comprising:
confirming, when a list display instruction instructing a list of editing objects inserted at a third reproduction time of the voice data to be displayed is received by the user, whether there is an editing object having an insertion time which belongs to a predetermined first time before or after the third reproduction time by referring to the object table; and
extracting, when it is confirmed that there is at least one first editing object as an editing object having the insertion time which belongs to the first time before and after the third reproduction time, information on the at least one first editing object and a unique identifier of a document corresponding to each of the information on the at least one first editing object from the object table, and then configuring an editing object list including the information on the at least one first editing object and the unique identifier of the document corresponding to the each of the information on the at least one first editing object, and displaying the editing object list on the screen.

10. The operating method of claim 9, further comprising:
reproducing the voice data from a fourth reproduction time corresponding to a time in which the second editing object is inserted when the editing object list is displayed on the screen, and then a selection instruction of information on a second editing object which is any one of the information on the at least one first editing object included in the editing object list is received by the user, and reflecting editing objects having an insertion time before the fourth reproduction time on the plurality of documents by referring to the object table, and then confirming information on an editing object according to each reproduction time recorded in the object table, and a unique identifier of a document whenever a reproduction time corresponding to a time in which each editing object recorded in the object table is inserted from the fourth reproduction time, and displaying a scene in which the editing object according to each reproduction time is inserted on the document having the unique identifier according to each reproduction time on the screen.

11-12. (canceled)

13. A non-transitory computer readable recording medium having a program recorded therein for allowing a computer to execute an operating method of an electronic apparatus capable of synchronizing between documents and voices through matching between a voice and an editing object when a user edits the document while recording the voice, the operating method comprising:
recording, when a voice recording start instruction is received by the user in a state in which a plurality of different documents are being edited, wherein unique identifiers for identifying respective documents are assigned to the plurality of documents, respectively, a voice applied through a microphone to generate voice data;
recording information on the editing object and a time of inserting the editing object and a unique identifier assigned to any one document to correspond to each other in an object table whenever inserting the editing object is completed in any one document among the plurality of documents by the user while recording the voice;
ending recording of the voice and data recording in the object table when a voice recording end instruction is received by the user; and
reproducing the voice data, when a reproduction instruction for the voice data is received by the user after the recording for the voice and the data recording in the object table are ended, and confirming information on the editing object and the unique identifier of the document according to each reproduction time, which are recorded in the object table whenever a reproduction time corresponding to the time of inserting each editing object recorded in the object table is completed is reached to display a scene in which the editing object is inserted according to each reproduction time in the document having the unique identifier according to each reproduction time on a screen.
